(19) United States
(12) Patent Application Publication
(10) Pub. No.: US 2011/0254412 A1
(43) Pub. Date: Oct. 20, 2011

(54) PIECE OF FURNITURE

(76) Inventor: Matteo RONDA, Thiene (VI) (IT)

(21) Appl. No.: 13/072,700

(22) Filed: Mar. 26, 2011

(30) Foreign Application Priority Data
Mar. 26, 2010 (IT) RM2010A000142

(51) Int. Cl. A47B 77/00; B23P 11/00; A47B 87/00

(52) U.S. Cl. 312/107; 29/428

(57) ABSTRACT

A piece of furniture can be made in a simple and cheap way, with a very high customization of the aesthetical features and it comprises a supporting structure formed by a single body made of a low density material, at least a functional fitting for receiving objects, the fitting being inserted inside an opening, wherein the functional fitting is at least partially in contact with the lower density material so as to implement a thermal insulation of the functional fitting, and it further comprises a covering surface applied as a cover of an external surface of the supporting structure.

### TECHNICAL FIELD

The present invention relates to a piece of furniture, destined to the use in public and domestic premises, in particular outdoor kitchens, of the type comprising a series of functional accessories allowing to contain products in insulated compartments.

### RELATED ART

In the furniture field, in particular the one used in the public premises, such as coffee bars and restaurants, the need for a continuous renewal and variations of the premises' aspect is felt, so as to adapt to the field trend and to the contingent situation in general. However, it appears clear that the costs linked to the production of pieces of furniture dedicated to such destinations are so as not to allow such continuous renewal.

Therefore the need is felt to have furniture products which could be implemented easily and economically and above all which can be customized, so as to satisfy the different needs.

Among the different possibilities for implementing pieces of furniture, the American patent application US 2009 0056257 describes a method for producing pieces of furniture by using panels made of foam material. Such method provides the preparation of such panels by moulding the foam material according to the wished graphical aspect, in particular so as to simulate a brick-like effect, and the assembly of such panels according to a predetermined configuration, so as to obtain several types of pieces of furniture and furniture products in general.

However, the union of such panels takes place by means of using connection systems such as glues, rivets and the like and, consequently, the assembly of the piece of furniture often reveals to be complicated. Furthermore, it can be easily comprehended that the structure of the piece of furniture as a whole is not particularly resistant, being fully formed by foam material, even if resins and other similar materials are added.

Furthermore, the structure implemented by the assembly with the panels is not immediately ready to receive drawers, windows and various types of accessories of functional type and, on the contrary, it will be necessary to provide specific additional structures to receive such members, however essential in the sofar described applications.

Consequently, the method for implementing furniture described in the above-mentioned patent reveals to be however poorly practical and surely not very suitable to meet the need for implementing customizable pieces of furniture suitable to the use in public premises, such as coffee bars and the like.

The use of polystyrene for implementing furniture is also described in the patent application US 2008/0163862, wherein members made of polystyrene coated with a layer of resin with Urethane/Quartz aggregates are used, conferring a higher structural resistance to the polystyrene and producing an effect of thermal insulation of the same. Such solution allows housing in the so-implemented piece of furniture even heavy stove objects producing a lot of heat, such as ovens and cooktops. However, in this way the polystyrene insulating capabilities are not exploited at best, on the contrary such material is suitably coated so as to avoid that the used stove objects are in contact with the same.

Therefore the technical problem underlying the present invention is to provide a piece of furniture allowing to obviate the drawbacks mentioned above by referring to the known art.

### ABSTRACT OF THE INVENTION

Such problem is solved by a piece of furniture comprising a supporting structure formed by a single body made of a low density material, the density being lower than about 250 kg/m³, the supporting structure having at least an opening, at least one functional fitting for receiving objects, the fitting being placed inside the opening, the functional fitting being at least partially in contact with the low density material so as to implement a thermal insulation of the functional fitting and a covering surface fixed at least as a cover of an external surface of the supporting structure.

Moreover, the invention also relates to a method for implementing such piece of furniture, comprising the steps of: modelling a block made of a low density material, with a density lower than about 250 kg/m³, so as to obtain a supporting structure provided with one or more openings, the openings being complementary shaped to a functional fitting to be inserted therein; fixing a covering surface to said supporting structure at least so as to cover an external surface of said supporting structure; inserting at least one functional fitting into the opening so that the fitting is at least partially in contact with the low density material to provide the thermal insulation thereof.

The present invention has some important advantages. The main advantage lies in the fact that the piece of furniture according to the present invention can be implemented in a simple and cheap way, with very high customization of the aesthetical features. Furthermore, the piece of furniture can be easily mounted, transported and installed, as well as it is immediately ready to receive various types of functional fittings without requesting any modification or additional members to the furniture supporting structure. At last, the method for implementing the same can be easily implemented and it allows a high flexibility in the features of the piece of furniture which it allows to produce.

Other advantages, features and use modes of the present invention will result evident by the following detailed descriptions of some embodiments, shown by way of example and not with limitative purpose.

### BRIEF DESCRIPTION OF THE DRAWINGS

The figures of the enclosed drawings will be referred to, wherein:

FIG. 1 is an exploded perspective view illustrating a piece of furniture according to the present invention; and

FIG. 2 is a perspective view illustrating the closing member of FIG. 1 during the use thereof.

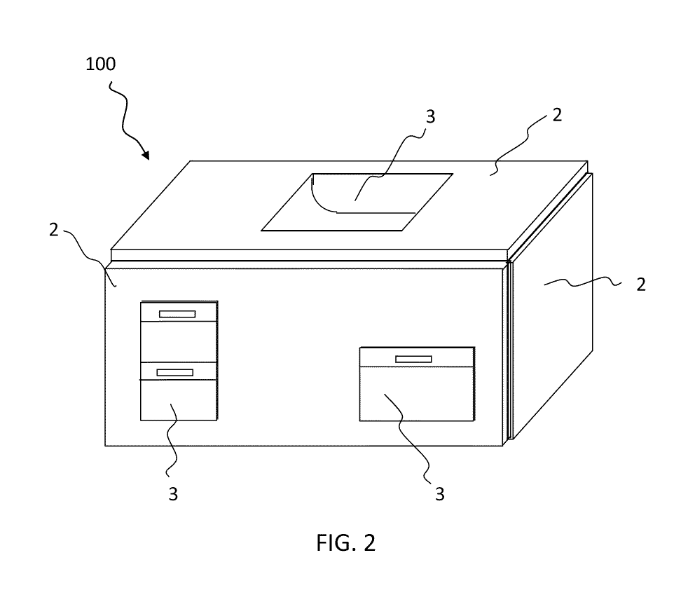

### DETAILED DESCRIPTION OF THE INVENTION

By referring to the figures, the piece of furniture according to the present invention is designated as a whole with the reference number 100 and, in the present embodiment example, is represented by a counter. As it will be better evident hereinafter, the concepts expressed in relation to such type of piece of furniture could immediately be applied even to other embodiments.

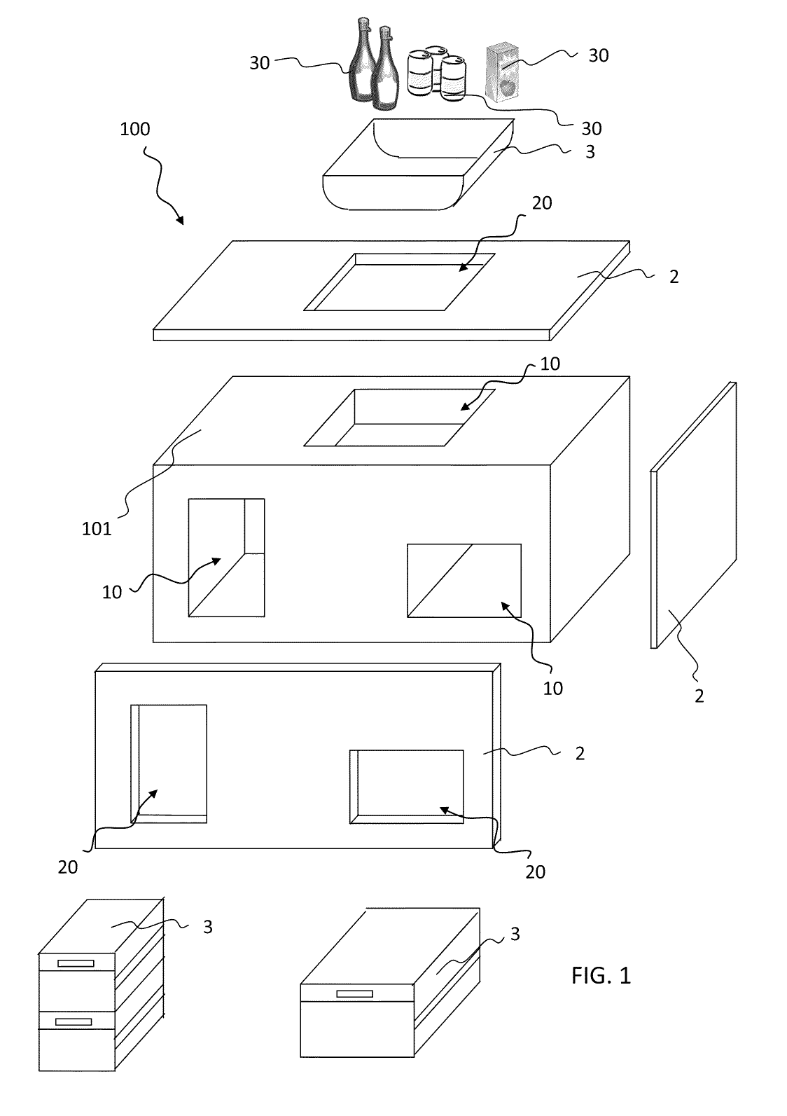

As it can be noted in FIG. 1, the piece of furniture 100 comprises a supporting structure 1 which is implemented by means of a single block made of foam polystyrene, more precisely sintered foam polystyrene (EPS) or extruded foam polystyrene (XPS), or, generally, other low density material. More precisely, experimentally it has been observed that the objects of the present invention could be achieved with a material having a density lower than about 250 kg/m³, or more preferably lower than about 100 kg/m³ or, still more preferably lower than about 50 kg/m³.

By way of example, possible materials suitable to implement the supporting structure 1, apart from the above-mentioned foam polystyrenes, the density thereof can vary between 20 and 100 kg/m³, could be used also the material known under the trade name of Styrofoam® by Dow Chemical Company, the density thereof usually is equal to 33 kg/m³, various types of wood, in particular cork and balsa (respectively 100 kg/m³ and 240 kg/m³), or foam polyurethane with density ranging between 10 and 250 kg/m³.

As it will be seen hereinafter, the piece of furniture according to the present invention could be conveniently implemented by means of a single block made of low density material, since, indeed thanks to the above-mentioned weights, it could be easily transported, at least in line with the usual pieces of furniture to be assembled.

The supporting structure 1 then has at least one opening 10, in particular a not through opening and in this case three openings, defining a housing compartment inside thereof at least a functional fitting 3 could be inserted, the features thereof will be described more in details hereinafter.

According to a preferred embodiment, the openings 10 in the supporting structure 1 are implemented by boring the starting block and by removing the material until obtaining the wished sizes and shapes of the openings 10. Such boring operation could be performed by both hot and cold milling or cutting of the material, even depending upon the type of used low density material. If expanded polystyrene is used, the hot wire cutting reveals to be particularly advantageous in terms of implementation easiness and cheapness.

In some cases, it will also be possible to implement the openings directly in a step for moulding the basis block, obviously for those materials which can be formed by such technology.

Once implemented the openings 10 in the supporting structure 1, the piece of furniture according to the present invention is provided with a covering surface 2 which is applied at least as a cover to an external surface 11 of the supporting structure 1. In the present embodiment, the covering surface 2 is applied at the upper, front and side surface of the supporting structure, so as to cover those portions of low density material in contact with outside and then which could easily be ruined or damaged.

The covering surface 2 can then be implemented by means of a plurality of different materials, generally with higher surface hardness with respect to the material thereof the supporting structure 1 is made.

A first example of covering surface, which advantageously allows a quick and simple application, is represented by specific hardening paints or resins 1 poured above the supporting structure 1, thus allowing a uniform and continuous covering of the same.

As alternative, plates or continuous plain surfaces made of various materials could be used, such as glass, both in plates and mosaic-like glass and in case mirrored glass, wood, such as for example teak or poplar, epoxy resins or composite resins with fibres, stones, such as for example pebbles, stones dipped in resin or bricks, metallic materials, such as for example stainless steel or pre-coated steel or even aluminium. Obviously, such list has to be considered purely as an example and it does not comprehend all material types which can be used.

Such materials could be used also combined therebetween, for example steel and resin or wood and resin.

The covering surface 2 further will have through openings 20, corresponding to those implemented on the support 1. In this way, the application of the covering surface 2 will not obstruct the access to the compartments defined by the openings 10.

The implementation of such openings can take place by using a plurality of panels of small sizes placed side by side therebetween so as to obtain a plain surface provided with the openings 20, or by cutting a starting plate, for example through boring, milling or laser cutting or water cutting.

The fixing of the covering surface 2 can take place with any suitable fixing means, for example implemented by glues or screws, rivets or nails. A particularly practical and advantageous solution in case the covering surface 2 is made by means of a plurality of panels placed side by side, consists in using double adhesive tape allowing to perform a quick and precise positioning of the single panels directly on the supporting structure 1. Still as alternative, for fixing the covering surface a technique similar to the “external insulation” technique used in the construction field could be used.

It is to be noted then that the covering surface 2 advantageously could be prepared with the wished pattern, so as to confer the wished aesthetical aspect to the piece of furniture 100. Furthermore, as already mentioned previously, it allows guaranteeing a greater surface toughness to the member 100.

Once applied the covering surfaces 2, the functional fittings 3 will be inserted inside the openings 10 and 20 which fittings, still by way of example, could be represented by drawers, shelves, hoppers or basins, all in case equipped with a respective closing door. It is then evident that such functional fittings 3 could be able to receive a series of objects 30, such as bottles, tans and containers in general inside thereof.

It is to be noted then that, as the supporting structure is implemented as a single block, the functional fitting 3, once positioned in the respective opening 10, that is the one complementary to the fitting 3, will be in contact at least partially with the low density material which will be able, indeed thanks to the features of the same, to implement a thermal insulation of the functional fitting 3.

In this way, the piece of furniture according to the present invention could be easily used as furniture for coffee bar or sideboard, by keeping cool the objects placed inside thereof.

In case of foam low density materials, the thermal insulation effect will be so that, by placing ice inside the functional fitting, the objects 30 could be kept cool for many many hours. In this way, it will be possible placing the low density member even outside, without the need for providing electrical connections or for equipping it with heavy components. The piece of furniture 100 advantageously will have the function of freezer or, as alternative, by using hot water, it could keep hot foods and beverages.

In any case, it is evident that the piece of furniture 100 could also be equipped with possible auxiliary fittings, such as for example a lighting system, refrigerating groups, thermal resistances, ventilation systems or air conditioning systems, batteries for the power supply of the same or power photovoltaic groups.

In conclusion, it has to be noted that the piece of furniture according to the present invention can be implemented in a quick and simple way, without requesting long and complex working phases. In addition, it could be easily customized, by implementing even a single model with the wished feature without difficulty and practically without influencing costs.

Furthermore, with respect to the known products, it will keep even a solid and resistant structure, even to the surface agents, by means of a specific choice in the covering surface 2. For this reason it could be easily used outside. Moreover, the possibility of keeping cool the products inside thereof for a long time without the need for electrical connections further fosters the use thereof outside.

As already mentioned, the customization of the member 100 could also relate the aesthetical features which could be varied according to practically infinite combinations thanks to the combined use of the supporting structure 1 and of the coating surface 2.

At last, it must be noted that a piece of furniture 100 could be combined with other analogous members, with different shapes and sizes, so as to implement a modular solution, which could be adapted to the different needs both in the use modes and in the arrangement suggested by the various applications thereto it can be assigned.

The present invention has been sofar described by referring to preferred embodiments. It is to be meant that other embodiments belonging to the same inventive core may exist, however within the protective scope of the herebelow reported claims.

1. A piece of furniture (100) comprising a supporting structure (1) formed by single body made of a low density material, said density being lower than about 250 kg/m³, said supporting structure (1) having at least one opening (10), and further comprising at least one fitting (3) for receiving objects (30), said at least one fitting (3) being placed inside said at least one opening (10) and being at least partially contacting said low density material so as to provide a thermal insulation of the fitting (3), and a covering surface (2) fixed as a cover to at least one external surface (11, 12, 13) of said supporting structure (1).

2. The piece of furniture (100) according to claim 1, wherein said material has a density lower than about 100 kg/m³.

3. The piece of furniture (100) according to claim 1 or 2, wherein said covering surface (2) has at least one through opening (20) corresponding to said at least one opening (10) provided on said supporting structure (1), so as to allow access to said at least one fitting (3).

4. The piece of furniture (100) according to any of the preceding claims, wherein said covering surface (2) comprises a plurality of panels fixed to said supporting structure (1) so as to provide a substantially continuous covering of said external surface (11, 12, 13).

5. The piece of furniture (100) according to any of the preceding claims, wherein said low density material is expanded polystyrene.

6. A method per the manufacturing of a piece of furniture (100), comprising the steps of: modelling a block made of a low density material, with a density lower than about 250 kg/m³, so as to provide a supporting structure (1) provided with one or more openings (10), said openings being complementary shaped to a fitting (3) to be inserted therein; fixing a covering surface (2) to said supporting structure (1) so as to cover at least one external surface (11, 12, 13) of said supporting structure (1); inserting at least one fitting (3) in said at least one opening (10) such that the fitting (3) contacts at least partially said low density material for providing a thermal insulation of the former.

7. The method according to claim 6, wherein said supporting structure (1) is formed by a step of boring the low density material block so as to remove material in correspondence of said at least one opening (10).

8. The method according to claim 7 or 8, wherein said covering surface (2) is formed by applying a plurality of panels to said supporting structure (1).

9. The method according to claim 7 or 8, wherein said covering surface (2) is formed by pouring hardening material on said supporting structure (1).

10. The method according to any of claims 6 a 9, comprising a further step of providing said covering surface (2) with at least one through opening (20) corresponding to said opening (10).
